(19) United States
(12) Patent Application Publication
(10) Pub. No.: US 2023/0314352 A1
(43) Pub. Date: Oct. 5, 2023

(54) SYSTEMS AND METHODS FOR MEASURING THERMAL CHARACTERISTICS OF AN OBJECT

(71) Applicant: UNIVERSITY OF TENNESSEE RESEARCH FOUNDATION, Knoxville, TN (US)

(72) Inventors: Ryan Joseph Spencer, Knoxville, TN (US); Yianni Karastamatis, Knoxville, TN (US); Uday Vaidya, Knoxville, TN (US); Ahmed Hassen, Knoxville, TN (US)

(73) Assignee: UNIVERSITY OF TENNESSEE RESEARCH FOUNDATION, Knoxville, TN (US)

(21) Appl. No.: 18/129,347

(22) Filed: Mar. 31, 2023

Related U.S. Application Data
(60) Provisional application No. 63/326,200, filed on Mar. 31, 2022.
(60) Provisional application No. 63/371,785, filed on Aug. 18, 2022.
(60) Provisional application No. 63/449,724, filed on Mar. 3, 2023.

(51) Int. Cl. G01N 25/16; G01N 1/44; G01N 35/00; G06T 7/00

(52) U.S. Cl. CPC G01N 25/16; G01N 1/44; G01N 35/0099; G06T 7/0002; G06T 2207/30148; G06T 2207/30141; G06T 2207/30152; G06T 2207/30204; G06T 2207/30164; G06T 2207/30136; G06T 2207/10048

(57) ABSTRACT

Provided are methods and apparatus for determining a coefficient of thermal expansion (CTE) of at least a portion of a test object. An example provided method includes (i) producing information describing a reference image of the test object portion during low-temperature excitation; (ii) heating the test object portion to a higher temperature; (iii) measuring a change in temperature of the test object portion; (iv) producing information describing an image of thermal change in displacement of the test object portion at the higher temperature; (v) comparing the information describing the image of thermal change in displacement of the test object portion at the higher temperature to the information describing the reference image to produce strain information describing heating-induced changes in strain in the test object portion; and (vi) producing CTE information by correlating the strain information with the change in temperature of the test object portion.

### CROSS-REFERENCE TO RELATED APPLICATIONS

This application claims the benefits of U.S. Provisional Patent Application No. 63/326,200, titled “SYSTEMS AND METHODS FOR MEASURING FIBER ORIENTATION AND LOCAL COEFFICIENT OF THERMAL EXPANSION”, filed Mar. 31, 2022, U.S. Provisional Patent Application No. 63/371,785, titled “A NONDESTRUCTIVE OPTICAL METHOD TO MEASURE LOCAL THERMAL EXPANSION COEFFICIENTS FOR ANISOTROPIC MATERIALS”, filed Aug. 18, 2022, and U.S. Provisional Patent Application No. 63/449,724, titled “SYSTEMS AND METHODS FOR MEASURING FIBER ORIENTATION AND LOCAL COEFFICIENT OF THERMAL EXPANSION”, filed Mar. 3, 2023, the disclosures of which are incorporated herein by reference in their entireties.

### STATEMENT REGARDING FEDERALLY SPONSORED RESEARCH

This invention was made with United States Government support under Grant No. DE-EE0006926 awarded by the U.S. Department of Energy (DOE). The United States Government has certain rights in the invention.

### FIELD OF DISCLOSURE

This disclosure relates generally to the technical field of material science, and more specifically, but not exclusively, to methods and apparatus for measuring thermal characteristics of at least a portion of an object.

### BACKGROUND

Conventional traditional methods for measuring thermal characteristics of materials have limitations. For example, thermal mechanical analysis and dilatometry are destructive methods of testing because they require very small sample sizes (e.g., <10 mm³). Thus, larger structures to be tested cannot be kept intact for testing due to sample extraction requirements of these measurement techniques. These measurement techniques also only measure one direction at a time. Thus, for anisotropic materials, multiple samples must be prepared with different orientations to measure a corresponding coefficient of linear thermal expansion. These techniques also do not test application of localized and thermal gradients, which are common in real-world applications.

Accordingly, there are previously unaddressed and long-felt industry needs for methods and apparatus which improve upon conventional methods and apparatus.

### SUMMARY

In some examples, provided is a method for determining a coefficient of thermal expansion (CTE) of a portion of a test object. In some examples, the method can include (i) capturing information describing a reference image of the portion of the test object during low-temperature excitation of the portion of the test object, (ii) heating the portion of the test object from the low-temperature to a higher temperature to produce a local thermal load, (iii) measuring, using an infrared sensor, a change in temperature of the portion of the test object, (iv) producing, using an optical sensor, information describing an image of thermal change in displacement of the portion of the test object at the higher temperature, (v) performing, automatically and using a computer processor, Digital Image Correlation (DIC) analysis by comparing (a) the information describing the image of thermal change in displacement of the portion of the test object at the higher temperature to (b) the information describing the reference image to produce strain information describing heating-induced changes in strain in the portion of the test object, and (vi) producing CTE information by correlating the strain information with the change in temperature of the portion of the test object.

In some embodiments, the method can further include locating, using a robotic arm, (i) the infrared sensor to a position where the infrared sensor can measure the change in temperature of the test object and (ii) the optical sensor to a position where the optical sensor can produce the information describing the image of thermal change in displacement of the portion of the test object at the higher temperature.

In some examples, the heating the portion of the test object can include at least one of: (i) imparting, using a laser, laser light on the portion of the test object, (ii) conducting heat to the portion of the test object via contact of the portion of the test object with another object having a temperature higher than that of the portion of the test object, (iii) convection heating the portion of the test object via contact of the portion of the test object with a gas having a temperature higher than that of the portion of the test object, (iv) imparting radiation on the portion of the test object, or (v) induction heating the portion of the test object.

In some examples, the method can further include applying a speckle pattern to the portion of the test object. In some examples, at least a portion of the speckle pattern forms a barcode. In some embodiments, the method can further include forming the speckle pattern by at least one of: (i) painting the speckle pattern on the portion of the test object, (ii) sputtering a material on the portion of the test object, or (iii) etching the portion of the test object.

In some examples, the test object can include at least one of: (i) an integrated circuit package, (ii) a printed circuit board, (iii) a solder joint, (iv) a semiconductor cross-section, (v) a semiconductor structure, or (vi) a semiconductor module.

In some embodiments, the test object can include a turbine engine component. In some examples, the turbine engine component can include at least one of: (i) a spinner, (ii) a fan blade, (iii) a compressor blade, (iv) a compressor stator, or (v) a shaft.

In some embodiments, the test object can include at least a portion of a railway vehicle. In some embodiments, the portion of the railway vehicle can include: (i) a wheel, (ii) an axle, (iii) a center plate, (iv) a side frame, (v) a spring plate, (vi) a bolster, or (vii) a coil spring.

In some examples, the test object can include at least a portion of: (i) a rail track, (ii) a rail fastener, (iii) a rail weld, or (iv) a railway sleeper.

In some examples, the test object can include a metal additive structure. In some embodiments, the test object can include at least two dissimilar materials.

In some examples, the method can further include forming, from the CTE information, a CTE distribution map that can include at least one of (i) a CTE vector field image or (ii) a CTE histogram image. In some embodiments, the method can further include (i) calculating, from the CTE information, a change in CTE information over time and (ii) calculating residual stress in the portion of the test object from the change in CTE information.

In some examples, provided is a system for determining a coefficient of thermal expansion of a portion of a test object. In some examples, the system can include (i) an optical sensor, (ii) an infrared sensor, (iii) a processor coupled to the optical sensor and the infrared sensor, and (iv) a memory device coupled to the processor.

In some embodiments, the memory device can store instructions configured to cause the processor to control: (i) capturing information describing a reference image of the portion of the test object during low-temperature excitation of the portion of the test object, (ii) heating the portion of the test object from the low-temperature to a higher temperature to produce a local thermal load, (iii) measuring, using the infrared sensor, a change in temperature of the portion of the test object, (iv) producing, using the optical sensor, information describing an image of thermal change in displacement of the portion of the test object at the higher temperature, (v) performing, automatically and using the processor, digital image correlation analysis by comparing (a) the information describing the image of thermal change in displacement of the portion of the test object at the higher temperature to (b) the information describing the reference image to produce strain information describing heating-induced changes in strain in the portion of the test object, and (vi) producing CTE information by correlating the strain information with the change in temperature of the portion of the test object.

In some examples, the system can further include a heating device configured to heat the portion of the test object to the higher temperature. In some examples, the heating device can be at least one of: (i) a laser, (ii) a conduction heater, (iii) a convection heater, (iv) a radiation-generating device, or (v) an induction heating device.

In some examples, the system can further include a robotic arm configured to locate the optical sensor and the infrared sensor, where the instructions can be further configured to cause the processor to locate, using the robotic arm, (i) the infrared sensor to a position where the infrared sensor can measure the change in temperature of the test object and (ii) the optical sensor to a position where the optical sensor can produce the information describing the image of thermal change in displacement of the portion of the test object at the higher temperature.

In some examples, the system can further include a device configured to apply a speckle pattern to the portion of the test object. In some examples, the device can be configured to apply the speckle pattern in a manner that forms at least a barcode. In some examples, the system can further include at least one of: (i) a paint application device configured to paint the speckle pattern, (ii) a sputtering device configured to sputter a material to form the speckle pattern, or (iii) an etching device configured to etch the speckle pattern.

In some examples, the test object can include at least one of: (i) an integrated circuit package, (ii) a printed circuit board, (iii) a solder joint, (iv) a semiconductor cross-section, (v) a semiconductor structure, or (vi) a semiconductor module.

In some embodiments, the test object can include a turbine engine component. In some examples, the turbine engine component can include at least one of: (i) a spinner, (ii) a fan blade, (iii) a compressor blade, (iv) a compressor stator, or (v) a shaft.

In some embodiments, the test object can include at least a portion of a railway vehicle. In some embodiments, the portion of the railway vehicle can include: (i) a wheel, (ii) an axle, (iii) a center plate, (iv) a side frame, (v) a spring plate, (vi) a bolster, or (vii) a coil spring.

In some examples, the test object can include at least a portion of: (i) a rail track, (ii) a rail fastener, (iii) a rail weld, or (iv) a railway sleeper.

In some examples, the test object can include a metal additive structure. In some embodiments, the test object can include at least two dissimilar materials.

In some embodiments, the memory device can further store instructions configured to cause the processor to control producing a CTE distribution map from the CTE information. In some examples, the system can further include at least one of: (i) a user display coupled to the processor and configured to display at least a portion of the CTE distribution map or (ii) a printer coupled to the processor and configured to print at least a portion of the CTE distribution map.

In some examples, the memory device can further store instructions configured to cause the processor to control: (i) calculating, from the CTE information, a change in CTE information over time and (ii) calculating residual stress in the portion of the test object from the change in CTE information.

In some examples, provided is a non-transitory computer-readable medium, comprising processor-executable instructions stored thereon configured to cause a processor to control: (i) capturing information describing a reference image of a portion of a test object during low-temperature excitation of a portion of the test object, (ii) heating the portion of the test object from the low-temperature to a higher temperature to produce a local thermal load, (iii) measuring, using an infrared sensor, a change in temperature of the portion of the test object, (iv) producing, using an optical sensor, information describing an image of thermal change in displacement of the portion of the test object at the higher temperature, (v) performing, automatically and using a computer processor, digital image correlation analysis by comparing (a) the information describing the image of thermal change in displacement of the portion of the test object at the higher temperature to (b) the information describing the reference image to produce strain information describing heating-induced changes in strain in the portion of the test object, and (vi) producing coefficient of thermal expansion information by correlating the strain information with the change in temperature of the portion of the test object. In some examples, the processor-executable instructions can be configured to cause the processor to initiate at least one of the steps described herein. In an embodiment, the processor-executable instructions can be configured to cause a processor to perform at least one of the steps described herein.

In some examples, the processor-executable instructions can be further configured to cause the processor to cause the processor to control a heating device configured to heat the portion of the test object to the higher temperature. In some examples, the processor-executable instructions can be further configured to cause the processor to cause the processor to control the heating the portion of the test object by controlling at least one of: (i) imparting, using a laser, laser light on the portion of the test object, (ii) conducting heat to the portion of the test object via contact of the portion of the test object with another object having a temperature higher than that of the portion of the test object, (iii) convection heating the portion of the test object via contact of the portion of the test object with a gas having a temperature higher than that of the portion of the test object, (iv) imparting radiation on the portion of the test object, or (v) induction heating the portion of the test object.

In some examples, the processor-executable instructions can be further configured to cause the processor to locate, using a robotic arm, (i) the infrared sensor to a position where the infrared sensor can measure the change in temperature of the test object and (ii) the optical sensor to a position where the optical sensor can produce the information describing the image of thermal change in displacement of the portion of the test object at the higher temperature.

In some examples, the processor-executable instructions can be further configured to cause the processor to control applying a speckle pattern to the portion of the test object. In some examples, at least a portion of the speckle pattern forms a barcode. In some examples, the processor-executable instructions can be further configured to cause the processor to cause the processor to control at least one of: (i) a paint application device configured to paint the speckle pattern, (ii) a sputtering device configured to sputter a material to form the speckle pattern, or (iii) an etching device configured to etch the speckle pattern.

In some examples, the test object can include at least one of: (i) an integrated circuit package, (ii) a printed circuit board, (iii) a solder joint, (iv) a semiconductor cross-section, (v) a semiconductor structure, or (vi) a semiconductor module.

In some embodiments, the test object can include a turbine engine component. In some examples, the turbine engine component can include at least one of: (i) a spinner, (ii) a fan blade, (iii) a compressor blade, (iv) a compressor stator, or (v) a shaft.

In some embodiments, the test object can include at least a portion of a railway vehicle. In some embodiments, the portion of the railway vehicle can include: (i) a wheel, (ii) an axle, (iii) a center plate, (iv) a side frame, (v) a spring plate, (vi) a bolster, or (vii) a coil spring.

In some examples, the test object can include at least a portion of: (i) a rail track, (ii) a rail fastener, (iii) a rail weld, or (iv) a railway sleeper.

In some examples, the test object can include a metal additive structure. In some embodiments, the test object can include at least two dissimilar materials.

In some examples, the processor-executable instructions can be further configured to cause the processor to control forming, from the CTE information, a CTE distribution map comprising at least one of (i) a CTE vector field image or (ii) a CTE histogram image.

In some examples, the processor-executable instructions can be further configured to cause the processor to cause the processor to control: (i) calculating, from the CTE information, a change in CTE information over time and (ii) calculating residual stress in the portion of the test object from the change in CTE information.

Features from any of the embodiments described herein can be used in combination with another embodiment in accordance with the general principles described herein. These and other embodiments, features, and advantages will be more fully understood upon reading this detailed description in conjunction with the accompanying drawings and claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

FIG. 1 depicts an example overview of methods for measuring thermal characteristics of objects.

FIG. 2 depicts a block diagram of an example computing device suitable for implementing examples of the disclosed subject matter.

FIG. 3A depicts an example apparatus configured to measure a coefficient of thermal expansion of at least a portion of a test object.

FIG. 3B depicts an example method for determining a coefficient of thermal expansion of at least a portion of a test object.

FIG. 4A depicts an example apparatus configured to measure fiber orientation of at least a portion of a reinforced composite material.

FIG. 4B depicts an example method for measuring fiber orientation of at least a portion of a reinforced composite material.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are methods and apparatuses for improved techniques for measuring thermal characteristics of an object. The provided methods are scalable, cost effective, and have a variety of practical applications.

In an example, a provided method for using Digital Image Correlation (DIC) analysis to characterize a test object and thus identify a coefficient of thermal expansion of the test object.

Also provided is a method for using digital image correlation analysis to characterize a reinforced composite material and thus identify fiber orientation within the reinforced composite material.

The provided techniques have a multitude of applications, including and not limited to, within the semiconductor industry, measuring a local, effective, and global coefficient of thermal expansion (CTE) for integrated circuit packages, printed circuit boards, solder joints, circuit cross-sections, and 3D structures and modules, as well as crack detection for IC packages, printed circuit boards, solder joints, circuit cross-sections, and 3D structures and modules.

The provided techniques further have applications relating to composite materials, such as validating a fiber orientation for mold flow analysis for fiber reinforced composites and their corresponding manufacturing methods, such as but not limited to, injection molding, extrusion-compression molding, and nonwoven composites, as well as detecting defects such as cracking, micro-cracking, delaminations, inclusions, voids, and any anisotropic constituents, in composite structures such as laminate woven composites, non-woven composites, discontinuous reinforced composites, core-structure composites (honeycomb, foam, etc.), and the like.

The provided techniques further have applications relating to the aerospace industry, such as measuring a local fiber orientation within discontinuous fiber composites (DFC) for aerospace composite structures, as well as crack detection within discontinuous fiber composites for aerospace composite structures. Further applications include measuring CTE and crack detection on turbine engine components such as spinners, fan blades, compressor blades, compressor stators, shafts, etc.

The provided techniques further have applications relating to rail transport, such as crack detection, residual stress measurements, CTE measurements, or a combination thereof on rail components such as wheels, axles, center plates, side frames, spring plates, bolsters, coil springs, rail tracks, rails, fasteners, welds, sleepers, etc.

The provided techniques further have applications relating to Metal Additive Manufacturing, such as defect detection in metal additive structures, such as cracking, layer separation, lack-of-fusion, or a combination thereof. Further applications include measuring CTE of metal additive structures, measuring residual stress of metal additive structures, or a combination thereof.

The provided techniques further have applications relating to adhesive bondline inspection, such as defect detection of adhesive bondlines by monitoring anisotropic thermal expansion response detecting inclusions, macro-voids, micro-voids, cohesion failure, adhesion failure, cracking, disbond/delamination, surface corrosion, contamination, zero-volume bonds (kissing bond), or combinations thereof. Further applications include measuring CTE between two different constituents/substrates. CTE mismatch can lead to cracking and pre-mature failure.

The provided techniques further have applications relating to the Oil and Gas industry, such as detecting defects in piping networks, such as cracking of pipes, cracking of welds, etc.

The examples disclosed hereby advantageously address the long-felt industry needs, as well as other previously unidentified needs, and mitigate shortcomings of conventional techniques. For example, the provided methods can advantageously be used to perform in situ characterization of test objects. The provided methods can also advantageously characterize test objects in a nondestructive manner (i.e., perform non-destructive testing). Further, the provided devices can store information generated by the provided techniques and subsequently both recall and analyze the information to identify long-term changes in characteristics (e.g., residual stress) of test objects.

Numerous examples are disclosed in this application's text and drawings. Alternate examples can be devised without departing from the scope of this disclosure. Additionally, conventional elements of the current teachings may not be described in detail, or may be omitted, to avoid obscuring aspects of the current teachings.

The following list of abbreviations, acronyms, and terms is provided to assist in comprehending the current disclosure and are not provided as limitations.
2D—Two-Dimensional
3D—Three-Dimensional
CAD—Computer Aided Drawing
CPU—Central Processing Unit
CT—Computed Tomography
CTE—Coefficient of Thermal Expansion
DIC—Digital Image Correlation
DSC—Differential scanning calorimetry
ε—Strain (e.g., increase of length/original length)
EMC—Epoxy Molding Compound
FD—Fiber Direction
FEA—Finite Element Analysis
FO—Fiber Orientation
FOV—Field of View
IC—Integrated Circuit
IR—Infrared
IRT—Infrared Thermography
LD—Laminate Direction
LDIC—Laser Digital Image Correlation (LDIC)
LED—Light Emitting Diode
PP/GF—A Compound of Polypropylene with Glass Fibers
PP/CF—A Compound of Polypropylene with Carbon Fibers
ppm—Parts Per Million
PTE—Pulsed Thermal Ellipsometry
σ—Stress (e.g., in Newtons/meter²)
T—Thermal Load, Temperature
tDIC—Thermal Digital Image Correlation
TD—Transverse Direction
TMA—Thermomechanical Analysis
q—Heat (e.g., in Joules)
QFN—Quad Flat No-Lead Package

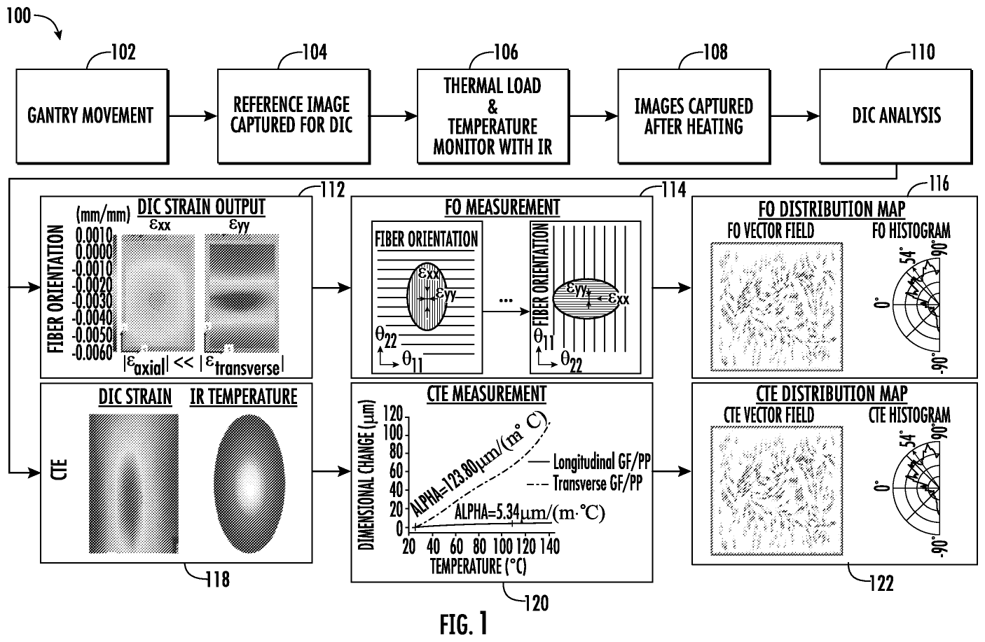

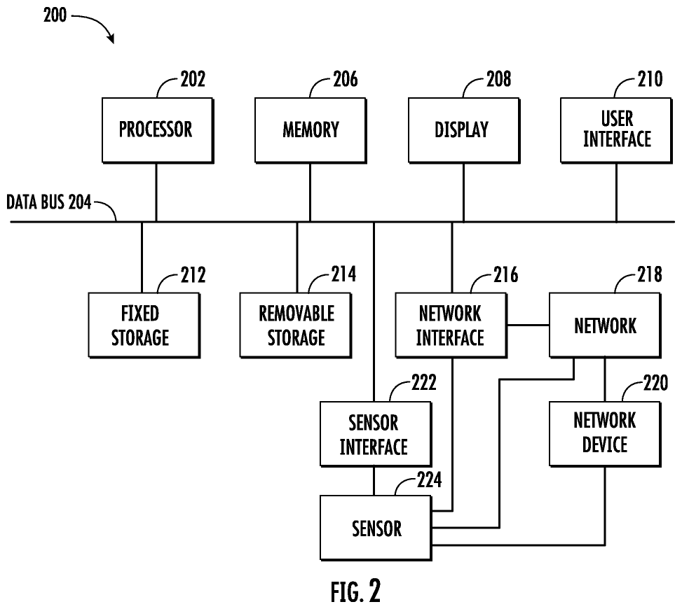

This description provides, with reference to FIGS. 1, 3B, and 4B, detailed descriptions of example methods for measuring thermal characteristics of at least a portion of a test object. Detailed descriptions of example apparatus for measuring thermal characteristics of at least a portion of a test object are provided with reference to FIGS. 2, 3A, and 4A.

The appendices filed herewith are incorporated herein by reference in their entireties and are a portion of this disclosure.

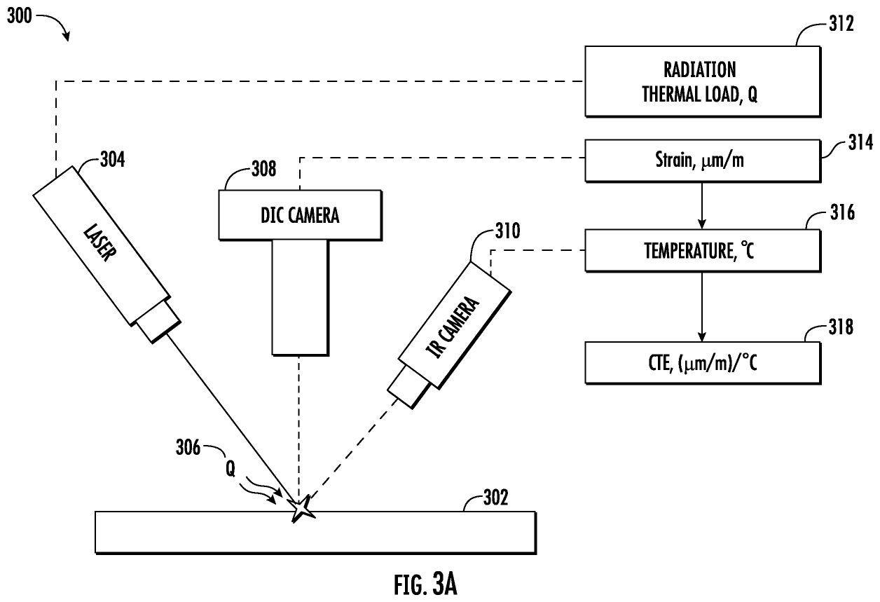

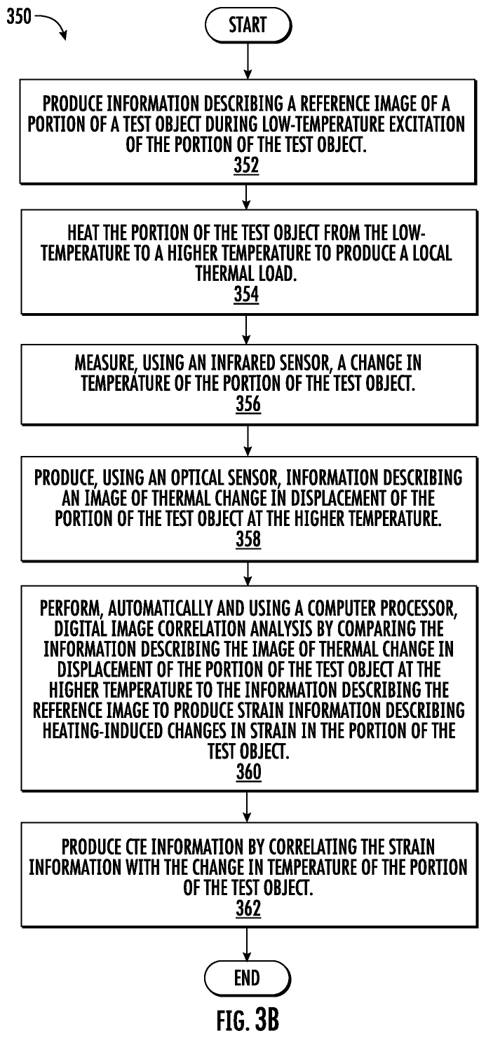

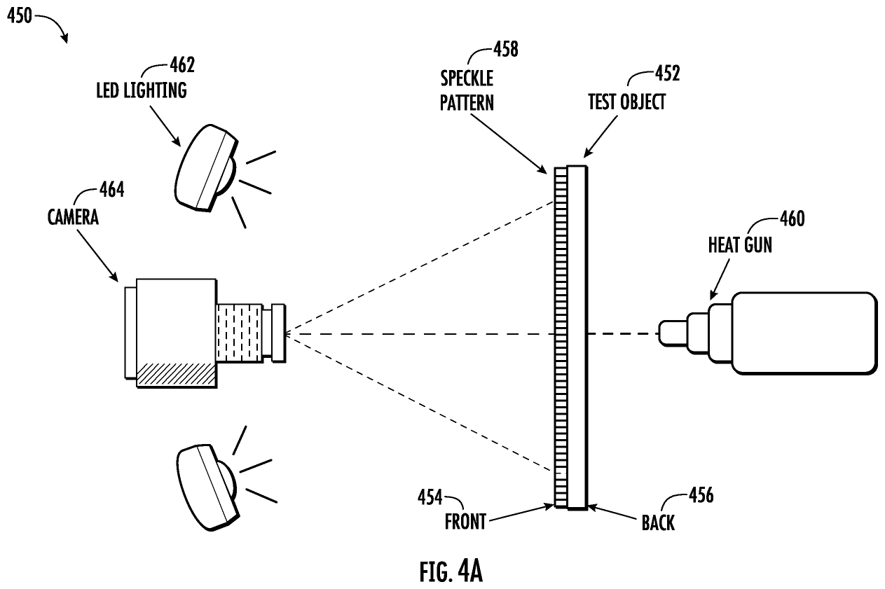

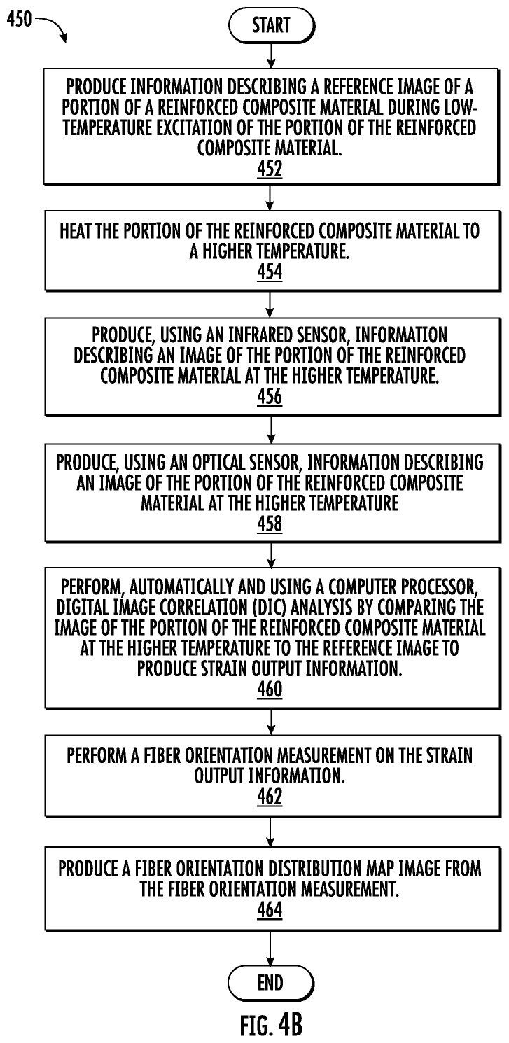

FIG. 1 depicts an example overview of methods for measuring thermal characteristics of objects 100. The example overview of methods for measuring thermal characteristics of objects 100 can be performed at least in part by the apparatus described hereby, such as the computing device 200 in FIG. 2, the example apparatus configured to measure a coefficient of thermal expansion 300 in FIG. 3A, the example apparatus configured to measure fiber orientation 400 in FIG. 4A, or a practicable combination thereof.

As illustrated in FIG. 1, at block 102, one or more of the devices described herein (e.g., a gantry, a robotic arm, or a combination thereof) can move to position an infrared sensor, an optical sensor, a heating device, or a combination thereof to at least one position where (i) the infrared sensor, the optical sensor, or both can produce information describing at least one respective image of at least a portion of a test object, (ii) the heating device can heat at least a portion of the test object, or (iii) both. In examples, the infrared sensor, the optical sensor, the heating device, or a combination thereof can be mounted to the gantry, the robotic arm, or both.

The test object is a tangible object. The test object cannot solely be a liquid. The test object cannot solely be a gas. In some examples, the test object can be a tangible object that is in a plastic state.

In some examples, a test object can include at least one of: (i) an integrated circuit package, (ii) a printed circuit board, (iii) a solder joint, (iv) a semiconductor cross-section, (v) a semiconductor structure, or (vi) a semiconductor module.

In some embodiments, the test object can include a turbine engine component. In some examples, the turbine engine component can include at least one of: (i) a spinner, (ii) a fan blade, (iii) a compressor blade, (iv) a compressor stator, or (v) a shaft.

In some embodiments, the test object can include at least a portion of a railway vehicle. In some embodiments, the portion of the railway vehicle can include: (i) a wheel, (ii) an axle, (iii) a center plate, (iv) a side frame, (v) a spring plate, (vi) a bolster, or (vii) a coil spring.

In some examples, the test object can include at least a portion of: (i) a rail track, (ii) a rail fastener, (iii) a rail weld, or (iv) a railway sleeper. In non-limiting examples, the gantry, the robotic arm, or both can be mounted to a railway vehicle (e.g., a railcar, a truck, a Hi-Rail truck) and can be moved to at least one position where the infrared sensor, the optical sensor, or both can produce information describing at least one respective image of at least a portion of a rail track.

In some examples, the test object can include a metal additive structure. In some embodiments, the test object can include at least two dissimilar materials.

In some embodiments, the test object can be a micro-electromechanical system. In some examples, the test object can be a semiconductor processor. In some embodiments, the test object can be a tangible component of a mechanical machine. In some embodiments, the test object can be an electronic component.

In some embodiments, the test object can be a tangible device described hereby. In some examples, descriptions herein relating to a portion of a test object can be interpreted as relating to an entirety of the test object, where practicable.

As illustrated in FIG. 1, at block 104, one or more of the devices described herein (e.g., an optical sensor, an infrared sensor, or both) can produce information describing a reference image of the portion of the test object during low-temperature excitation of the portion of the test object. In examples, the reference image can serve as an image to which other images can be compared. In some examples, at least a portion of the reference image is of light in the visible spectrum. In some examples, at least a portion of the reference image is of light in the infrared spectrum.

Additional information describing at least one characteristic of the portion of the test object can be recorded at the time the reference image is taken. For example, a temperature of the portion of the test object, an ambient temperature of an atmosphere in which the test object is located, or a combination thereof can be recorded.

In some examples, the reference image can include information describing at least one landmark of at least a portion of the test object. Examples of landmarks include, and are not limited to, an edge of the portion of the test object, at least a portion of a speckle pattern on the portion of the test object, at least a portion of a speckle pattern in the portion of the test object, at least a portion of a speckle pattern that is part of the portion of the test object, a depression in the portion of the test object, a raised protrusion on the portion of the test object, a surface defect on the portion of the test object, or a combination thereof.

As illustrated in FIG. 1, at block 106, one or more of the devices described herein can apply a thermal load to at least the portion of the test object. The thermal load can be applied by heating at least the portion of the test object to a temperature higher than the temperature of the portion of the test object at the time the reference image was taken. In examples, the portion of the test object can be heated to a specific temperature for testing. In some examples, the portion of the test object can be heated to a temperature within a range of specific temperatures. Example techniques for applying the thermal load are described in further detail hereby.

In some examples, the temperature of at least the portion of the test object can be sensed using a temperature sensor, an infrared camera, an infrared sensor, or a combination thereof. The temperature sensor can be a thermometer. In some examples, the temperature sensor, the infrared camera, the infrared sensor, or the combination thereof can produce information describing the temperature of at least the portion of the test object. In some examples, the information describing the temperature of at least the portion of the test object can be recorded, retrieved, displayed, printed, or a combination thereof. In some examples, information describing images of the least the portion of the test object can be recorded, retrieved, displayed, printed, or a combination thereof while the portion of the test object is being heated. In some examples, the temperature of at least the portion of the test object can be monitored over a period of time.

As illustrated in FIG. 1, at block 108, one or more of the devices described herein can produce, such as with an optical sensor, information describing an image of thermal change in displacement of at least a portion of the test object at a temperature higher than that of the portion of the test object at the time the reference image was taken. In some examples, the information describing the image of thermal change in displacement can be captured over time during the heating of at least the portion of the test object. In other words, one or more of the devices described herein can record video of the thermal change in displacement over time during the heating of at least a portion of the test object.

As illustrated in FIG. 1, at block 110, one or more of the devices described herein can perform Digital Image Correlation (DIC) analysis by comparing the information describing the image of thermal change in displacement of the portion of the test object at the higher temperature to the information describing the reference image. This comparison can produce strain information describing heating-induced changes in strain in the portion of the test object.

Digital Image Correlation (DIC) analysis is a technique for characterizing at least a portion of the test object by comparing at least the first image of the portion of the test object to at least a second image of the portion of the test object. In examples, the first image can be a reference image to which other images are compared.

In examples, when performing DIC analysis, the first image and a second image can be images of the portion of the test object with a portion being illuminated using visible light. An optical sensor senses the visible light and converts visible light into information describing an image of the portion of the test object. In examples, the first image and the second image can be infrared (IR) images of the portion of the test object. To characterize the portion of the test object, the portion of the test object is subjected to different environmental conditions when the second image is captured, relative to environmental conditions existing when the first image is captured. In a nonlimiting example, the temperature of the portion of the test object can be different when the second image is captured, relative to the temperature when the first image is captured. Thus, DIC analysis compares images of the portion of the test object under different environmental conditions, where the images indicate differing characteristics of the portion of the test object under those different environmental conditions.

In an example of DIC analysis, a first image of the portion of the test object and a second image of the portion of the test object are captured using visible light. The first image can be taken when the test object is not subjected to an external force that induces strain in the test object. The second image can be taken when the test object is subjected to an external force that induces strain in the test object. Comparing a first difference in location between two landmarks in the first image to a second difference in location between the same two landmarks in the second image can indicate a displacement due to the applied external force. Strain induced in the test object due to the applied external force can then be calculated from the first difference in location and the displacement. In further example of DIC analysis, a first image of the portion of the test object and a second image of the portion of the test object are captured using visible light. The first image can be taken when the test object is not subjected to a thermal load that induces strain in the test object. The second image can be taken when the test object is subjected to a thermal load that induces strain in the test object. Comparing a first difference in location between two landmarks in the first image to a second difference in location between the same two landmarks in the second image can indicate a displacement due to the thermal load. Strain induced in the test object due to the applied external force can then be calculated from the first difference in location and the displacement. A third image of the portion of the test object that is an infrared image can be captured at the time the first image is captured and during low-temperature excitation of the portion of the test object. The third image can be used as an infrared reference image. A fourth image of the portion of the test object that is also an infrared image can be captured at the time the second image is captured and during a time when the thermal load is applied to the portion of the test object. Comparing the third image to the fourth image can indicate a change in temperature of the portion of the test object resulting from the thermal load. Subsequently, a coefficient of thermal expansion (CTE) of the portion of the test object can be calculated from the displacement due to the thermal load, the first difference in location, and the change in temperature of the portion of the test object resulting from the thermal load.

The information produced by the digital image correlation analysis can be used as a part of techniques for measuring thermal characteristics of at least a portion of a test object. For example, techniques for identifying and measuring fiber orientation (FO) of a test object that is a reinforced composite material are described in reference to blocks 112-116 in FIG. 1.

As illustrated in FIG. 1, at block 112, one or more of the devices described herein can use the strain information describing the heating-induced changes in strain in the portion of the test object. In examples, the strain information can describe a measured strain of the portion of the test object at the higher temperature in at least two dimensions.

As illustrated in FIG. 1, at block 114, one or more of the devices described herein can perform a fiber orientation measurement on the strain information.

As illustrated in FIG. 1, at block 116, one or more of the devices described herein can produce a fiber orientation distribution map image, a fiber orientation histogram image, or both from the fiber orientation measurement.

In another example, techniques for determining a coefficient of thermal expansion (CTE) of at least a portion of a test object are described in reference to blocks 118-122 of FIG. 1.

As illustrated in FIG. 1, at block 118, one or more of the devices described herein can use the strain information describing the heating-induced changes in strain in the portion of the test object. In examples, the strain information can describe a measured strain of the portion of the test object at the higher temperature in at least two dimensions. In examples, one or more of the devices described herein can use information describing temperature of at least the portion of the test object. In examples, the information describing temperature of at least the portion of the test object can describe a measured change in temperature of the least the portion of the test object at the higher temperature in at least two dimensions. In examples, the information describing temperature of at least the portion of the test object can describe a measured temperature of the least the portion of the test object at the higher temperature in at least two dimensions.

As illustrated in FIG. 1, at block 120, one or more of the devices described herein can calculate a coefficient of thermal expansion of the portion of the test object, thus producing CTE information, by correlating the strain information with the change in temperature of the portion of the test object. In examples, the change in temperature of the portion of the test object can be calculated by determining difference between the information describing the temperature of at least a portion of the test object at the higher temperature and information describing the temperature at a lower temperature (i.e., when the reference image was captured).

As illustrated in FIG. 1, at block 122, one or more of the devices described herein can form, from the CTE information, a CTE distribution map comprising at least one of a CTE vector field image or a CTE histogram image. In an example, one or more of the devices described herein can calculate, from the CTE information, a change in CTE information over time and can calculate residual stress in the portion of the test object from the change in CTE information.

In another example, provided are techniques for detecting defects of at least a portion of a test object. One or more of the devices described herein can compare the strain information describing the heating-induced changes in strain in the portion of the test object to the information describing the reference image of the portion of the test object during low-temperature excitation of the portion of the test object to identify local irregularities in the strain information. The local irregularities can indicate with the presence and location of defects in the portion of the test object. Defects that can be detected include cracking, micro-cracking, delaminations, inclusions, voids, and any anisotropic constituents.

We now turn to FIG. 2.

FIG. 2 illustrates an example computing device 200 suitable for implementing examples of the disclosed subject matter. In examples, a computing device such as computing device 200 can control, monitor, initiate, report, or a combination thereof at least a part of a method described hereby. In examples, a computing device such as computing device 200 can display (e.g., via display 208 in FIG. 2) an image that enables a user to control, monitor, program, or a combination thereof at least a part of a device described hereby. In examples, a computing device such as computing device 200 can receive user input (e.g., via user interface 210 in FIG. 2) that enables the user to control, monitor, program, or a combination thereof at least a part of a device described hereby.

In examples, a computing device such as computing device 200 can map a scanning motion of a gantry, robotic arm, or both. In examples, a computing device such as computing device 200 can record, retrieve, or both information describing a position of a gantry, robotic arm, or both. In examples, a computing device such as computing device 200 can control operation of the gantry, the robotic arm, or both.

In examples, a computing device such as computing device 200 can perform measuring operations described hereby, sensing operations described hereby, information collection operations described hereby, information analysis operations described hereby, information reporting operations described hereby, or a combination thereof.

In examples, aspects of the computing device 200 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented using hardware devices, computer network devices, the like, or a combination thereof. The configuration depicted in FIG. 2 is an illustrative example and is not limiting.

In some examples, the computing device 200 can include a processor 202, a data bus 204, a memory 206, a display 208, a user interface 210, a fixed storage device 212, a removable storage device 214, a network interface 216, a network 218, a network device 220, a sensor interface 222, a sensor 224, the like, or a combination thereof. These elements are described in further detail herein.

The processor 202 can be a hardware-implemented processing unit configured to control at least a portion of operation of the computing device 200. The processor 202 can perform logical and arithmetic operations based on processor-executable instructions stored within the memory 206. The processor 202 can be configured to execute instructions which cause the processor 202 to initiate at least a part of a method described hereby. In an example, the processor 202 can interpret instructions stored in the memory 206 to initiate at least a part of a method described hereby. In an example, the processor 202 can execute instructions stored in the memory 206 to initiate at least a part of a method described hereby. The instructions, when executed by the processor 202, can transform the processor 202 into a special-purpose processor that causes the processor to perform at least a part of a function described hereby. The processor 202 can also be referred to as a central processing unit (CPU), a special-purpose processor (e.g., a non-generic processor), or both.

The processor 202 can comprise or be a component of a physical processing system implemented with one or more processors. In some examples, the processor 202 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a suitable physical device configured to manipulate information (e.g., calculating, logical operations, the like, or a combination thereof), the like, or a combination thereof.

The data bus 204 can couple components of the computing device 200. The data bus 204 can enable information communication between the processor 202 and one or more components coupled to the processor 202. In some examples, the data bus 204 can include a data bus, a power bus, a control signal bus, a status signal bus, the like, or a combination thereof. In an example, the components of the computing device 200 can be coupled together to communicate with each other using a different suitable mechanism.

The memory 206 generally represents any type or form of volatile storage device, non-volatile storage device, medium, the like, or a combination thereof. The memory 206 can store data, processor-readable instructions, the like, or a combination thereof. In an example, the memory 206 can store data, load data, maintain data, or a combination thereof. In an example, the memory 206 can store processor-readable instructions, load processor-readable instructions, maintain processor-readable instructions, or a combination thereof. In some embodiments, the memory 206 can store computer-readable instructions configured to cause a processor (e.g., the processor 202) to initiate performing at least a portion of a method described hereby. The memory 206 can be a main memory configured to store an operating system, an application program, the like, or a combination thereof. The memory 206 can be configured to store a basic input-output system (BIOS) which can control basic hardware operation such as interaction of the processor 202 with peripheral components. The memory 206 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 206 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, the like, or a combination thereof) and is configured to provide the information to the processor 202.

The display 208 can include a component configured to visually convey information to a user of the computing device 200. In examples, the display 208 is a video display screen, such as a light-emitting diode (LED) screen.

The user interface 210 can include user devices such as a switch, a keypad, a touch screen, a microphone, a speaker, an audio reproduction device, a jack for coupling the computing device to an audio reproduction device, the like, or a combination thereof. The user interface 210 can optionally include a user interface controller. The user interface 210 can include a component configured to convey information to a user of the computing device 200, a component configured to receive information from the user of the computing device 200, or both.

The fixed storage device 212 can include one or more hard drive, flash storage device, the like, or a combination thereof. The fixed storage device 212 can be an information storage device which is not configured to be removed during use. The fixed storage device 212 can optionally include a fixed storage device controller. The fixed storage device 212 can be integral with the computing device 200 or can be separate and accessed through an interface.

The removable storage device 214 can be integral with the computing device 200 or can be separate and accessed through other interfaces. The removable storage device 214 can be an information storage device which is configured to be removed during use, such as a memory card, a jump drive, a flash storage device, an optical disk, the like, or a combination thereof. The removable storage device 214 can optionally include a removable storage device controller. The removable storage device 214 can be integral with the computing device 200 or can be separate and accessed through an interface.

In examples, a computer-readable storage medium such as one or more of the memory 206, the fixed storage device 212, the removable storage device 214, a remote storage location, the like, or a combination thereof can store non-transitory computer-executable instructions configured to cause a processor (e.g., the processor 202) to implement at least an aspect of the present disclosure.

In examples, the non-transitory computer-readable medium can include processor-executable instructions stored thereon that are configured to cause the processor 202 to control, monitor, sense, initiate, or a combination thereof at least a part of a method described hereby.

The network interface 216 can couple the processor 202 (e.g., via the data bus 204) to the network 218 and enable exchanging information between the processor 202 and the network 218. In some examples, the network interface 216 can couple the processor 202 (e.g., via the data bus 204) to the network 218 and enable exchanging information between the processor 202 and the sensor 224. For example, the network interface 216 can enable the processor 202 to communicate with one or more other network devices 220. The network interface 216 can couple to the network 218 using any suitable technique and any suitable protocol. In some examples, the network interface 216 can include a data bus, a power bus, a control signal bus, a status signal bus, the like, or a combination thereof. Example techniques and protocols the network interface 216 can be configured to implement include digital cellular telephone, WiFi™, Bluetooth®, near-field communications (NFC), the like, or a combination thereof.

The network 218 can couple the processor 202 to one or more other network devices. In some examples, the network 218 can enable exchange of information between the processor 202 and the one or more other network devices 220. In some examples, the network 218 can enable exchange of information between the processor 202 and the sensor 224. The network 218 can include one or more private networks, local networks, wide-area networks, the Internet, other communication networks, the like, or a combination thereof. In some examples, the network 218 can be a wired network, a wireless network, an optical network, the like, or a combination thereof.

In some embodiments, the network device 220 can store computer-readable instructions configured to cause a processor (e.g., the processor 202) to initiate performing at least a portion of a method described hereby. In an example, the one or more other network devices 220 can store non-transitory computer-executable instructions configured to cause a processor (e.g., the processor 202) to implement at least an aspect of the present disclosure. The non-transitory computer-executable instructions can be received by the processor 202 and implemented using at least a portion of techniques described hereby. In another example, information described hereby can be stored in the fixed storage device 212, the removable storage device 214, the network device 220, the like, or a combination thereof.

The network device 220 can include the sensor 224, a hardware device configured to couple the network 218 to the sensor 224, a server, a digital information storage device, the like, or a combination thereof.

In some examples, the network device 220 can include user devices such as a switch, a keypad, a touch screen, a microphone, a speaker, an audio reproduction device, a jack for coupling the computing device to an audio reproduction device, the like, or a combination thereof. The network device 220 can optionally include a user interface controller. The network device 220 can include a component configured to convey information to a user of the computing device 200, a component configured to receive information from the user of the computing device 200, or both.

In some examples, all the components illustrated in FIG. 2 need not be present to practice the present disclosure. Further, the components can be coupled in different ways from those illustrated.

The sensor interface 222 can couple the processor 202 (e.g., via the data bus 204) to the sensor 224. In some examples, the sensor interface 222 can couple the processor 202 (e.g., via the data bus 204) to the sensor 224 and enable exchanging information between the processor 202 and the sensor 224. For example, the sensor interface 222 can enable the processor 202 to receive, from the sensor 224, analog information and/or digital information describing at least one state of at least one condition of at least a portion of a test object. The sensor interface 222 can couple to the sensor 224 using any suitable technique and any suitable protocol. In some examples, the sensor interface 222 can perform analog-to-digital conversion, digital-to-analog conversion, or a combination thereof. In some examples, the sensor interface 222 can include a data bus, a power bus, a control signal bus, a status signal bus, the like, or a combination thereof. Example techniques and protocols the sensor interface 222 can be configured to implement include digital cellular telephone, WiFi™, Bluetooth®, near-field communications (NFC), the like, or a combination thereof.

The sensor 224 can sense at least one condition of at least a portion of a test object. In examples, the sensor 224 can produce an analog output indicating the at least one state, a digital output indicating the at least one state, or both. The sensor 224 can produce an output of the at least one state using any suitable technique, any suitable protocol, or both. In some examples, the sensor 224 can perform analog-to-digital conversion, digital-to-analog conversion, or a combination thereof. In some examples, the sensor 224 can include an infrared camera, a data bus, a power bus, a control signal bus, a status signal bus, the like, or a combination thereof. Example techniques and protocols the sensor 224 can be configured to implement include digital cellular telephone, WiFi™, Bluetooth®, near-field communications (NFC), the like, or a combination thereof. In examples, the sensor 224 can be an optical sensor, an infrared sensor, a temperature sensor, an IR camera, a camera configured to capture visible light, a video camera, a still camera, or a combination thereof. In examples, the sensor 224 can be a sensor configured to detect a position of a robotic arm to provide feedback for positioning the robotic arm.

We now turn to FIG. 3A.

FIG. 3A depicts an example apparatus configured to measure a coefficient of thermal expansion 300 of at least a portion of a test object 302. The apparatus configured to measure a coefficient of thermal expansion 300 can be configured for perform at least a part of a method described hereby, such as the example method for determining a coefficient of thermal expansion 350 described in reference to FIG. 3B.

The example apparatus configured to measure a coefficient of thermal expansion 300 can include a laser 304 configured to apply heat energy 306 to at least a portion of the test object 302, a digital image correlation (DIC) camera 308, and an infrared (IR) camera 310.

The laser 304 can be configured as a local radiant thermal source that is configured to apply heat energy 306 (“Q” in FIG. 3A) to at least the portion of the test object 302. The heat energy 306 can provide a thermal load that raises a temperature of the portion of the test object 302 from a lower temperature to a higher temperature. In a non-limiting example, the laser 304 can have a power of 2.5 W at 450 nm wavelength. In some examples, heating at least the portion of the test object 302 can induce isotropic thermal expansion strain in the portion of the test object 302. In some examples, heating at least the portion of the test object 302 can induce anisotropic thermal expansion strain in the portion of the test object 302. In some examples, heating homogeneous metals can cause isotropic thermal expansion. In some examples, heating composite materials can cause anisotropic thermal expansion.

In some examples, measuring Fiber Orientation (FO) requires measuring anisotropic thermal expansion of the portion of the test object 302.

The example apparatus configured to measure a coefficient of thermal expansion 300 can include, additionally or alternatively to laser 304, other heating devices configured to apply the heat energy 306 to at least the portion of the test object 302, such as a heat gun, a conduction heater, a convection heater, a radiation-generating device, an induction heating device, or a combination thereof.

The DIC camera 308 can be an optical sensor. The DIC camera 308 can be configured to produce information describing an image of anisotropic thermal expansion of the portion of the test object 302. In examples, the DIC camera 308 can be configured to produce information describing an image of anisotropic thermal expansion of local fibers when the portion of the test object 302 includes a reinforced composite material. The DIC camera 308 can thus provide information describing a strain of the portion of the test object 302.

The IR camera 310 can be an infrared sensor. The IR camera 310 can be configured to produce information describing an image of a temperature distribution of at least a portion of the test object 302. The temperature distribution can come about as a result of the thermal load applied to the portion of the test object 302. The IR camera 310 can thus provide information describing a temperature of the portion of the test object 302.

In examples, the laser 304, the DIC camera 308, the IR camera 310, a heating device, or a combination thereof can be electrically coupled to the example computing device 200. The example computing device 200 can be configured to control operation of the laser 304, the DIC camera 308, the IR camera 310, the heating device, or a combination thereof. The example computing device 200 can be configured to receive information from the laser 304, the DIC camera 308, the IR camera 310, the heating device, or a combination thereof.

In examples, the example computing device 200 can control operation of the heating device in response to the information from the temperature sensor, the infrared camera, the infrared sensor, the DIC camera 308, the IR camera 310, the heating device, or a combination thereof to control a temperature of at least a portion of a test object. In examples, the example computing device 200 can control operation of the heating device in a closed-loop manner to regulate a temperature of at least a portion of a test object to a specific temperature or range of temperatures. In examples, the example computing device 200 can receive, store, retrieve, or a combination thereof information describing the specific temperature or the range of temperatures.

In examples, the example computing device 200 can control operation of the heating device to prevent overheating a portion of a test object. In examples, the example computing device 200 can control operation of the heating device to prevent a temperature of at least a portion of a test object from exceeding to a maximum temperature. In examples, the example computing device 200 can receive, store, retrieve, or a combination thereof information describing the maximum temperature.

The example computing device 200 can correlate the image of the temperature distribution of at least the portion of the test object 302 with the information describing an image of anisotropic thermal expansion of the portion of the test object 302 to identify a quantity of local displacement of the portion of the test object 302 due to a respective temperature distribution of the portion of the test object 302. This correlation can produce a measurement of a coefficient of thermal expansion (CTE) of the portion of the test object 302.

The example apparatus configured to measure a coefficient of thermal expansion 300 can include a robotic arm configured to locate the optical sensor and the infrared sensor. The example computing device 200 can be configured to locate, using the robotic arm, IR camera 310 to a position where the IR camera 310 can measure the change in temperature of the portion of the test object 302. The example computing device 200 can be configured to locate, using the robotic arm, the IR camera 310 to a position where the IR camera 310 can measure the change in temperature of the portion of the test object. The example computing device 200 can be configured to locate, using the robotic arm, the DIC camera 308 to a position where the DIC camera 308 can produce the information describing the image of thermal change in displacement of the portion of the test object 302 at the higher temperature.

The example apparatus configured to measure a coefficient of thermal expansion 300 can include a device configured to apply a speckle pattern to the portion of the test object 302. In some examples, the device can be configured to apply the speckle pattern in a manner that forms at least a barcode. In some examples, the device can include at least one of: (i) a paint application device configured to paint the speckle pattern, (ii) a sputtering device configured to sputter a material to form the speckle pattern, or (iii) an etching device configured to etch the speckle pattern.

In non-limiting examples, LED lighting can provide incident light (e.g., visible light) on at least the portion of the test object 302 to enable the DIC camera 308 to produce (i) information describing a reference image of the portion of the test object 302 during low-temperature excitation of the portion of the test object 302, (ii) information describing an image of the portion of the test object 302 at a higher temperature, or (iii) both.

In some embodiments, the example computing device 200 can control producing a CTE distribution map from CTE information. The example apparatus configured to measure a coefficient of thermal expansion 300 can include at least one of: (i) a user display coupled to the example computing device 200 and configured to display at least a portion of the CTE distribution map or (ii) a printer coupled to the example computing device 200 and configured to print at least a portion of the CTE distribution map.

In some examples, the example computing device 200 can be configured to control: (i) calculating, from the CTE information, a change in CTE information over time and (ii) calculating residual stress in the portion of the test object 302 from the change in CTE information. The example apparatus configured to measure a coefficient of thermal expansion 300 can include a user display coupled to the example computing device 200 and configured to display information describing at least a portion of the change in CTE information over time, information describing residual stress in the portion of the test object 302, or both. The example apparatus configured to measure a coefficient of thermal expansion 300 can include a printer coupled to the example computing device 200 and configured to print information describing at least a portion of the change in CTE information over time, information describing residual stress in the portion of the test object 302, or both.

We now turn to FIG. 3B.

FIG. 3B depicts an example method for determining a coefficient of thermal expansion 350 of at least a portion of a test object. The method for determining a coefficient of thermal expansion 350 can be performed at least in part by the apparatus described hereby, such as the computing device 200 in FIG. 2, the example apparatus configured to measure a coefficient of thermal expansion 350 in FIG. 3A, or a practicable combination thereof.

As illustrated in FIG. 3B, at block 352, one or more of the devices described herein can produce information describing a reference image of a portion of a test object during low-temperature excitation of the portion of the test object. In non-limiting examples, the low-temperature excitation of the portion of the test object can occur at a room temperature (e.g., between 40 F and 120 F, inclusive).

In some examples, the method 350 can further include applying a speckle pattern to the portion of the test object. The speckle pattern can be used as a focal point for an infrared sensor, an optical sensor, or both, as described herein.

In some examples, at least a portion of the speckle pattern forms a barcode. The barcode can be a two-dimensional barcode, a three-dimensional barcode, or a combination thereof. In embodiments, the barcode can both identify the test object and be a focal point for an infrared sensor, an optical sensor, or both, as described herein. In some examples, the barcode can be disposed on the test object, a part of the test object, molded into the test object, etched into the test object, or a combination thereof.

In examples, at least a portion of the speckle pattern can have a Gaussian distribution of speckles around a central location. The Gaussian distribution can enable measuring different distances between points of the test object when the test object is at different temperatures.

In some embodiments, the method can further include forming the speckle pattern by at least one of: (i) painting the speckle pattern on the portion of the test object, (ii) sputtering a material on the portion of the test object, or (iii) etching the portion of the test object.

As illustrated in FIG. 3B, at block 354, one or more of the devices described herein can heat the portion of the test object from the low-temperature to a higher temperature to produce a local thermal load. The term “higher temperature” describes a temperature relative to the low-temperature excitation of the portion of the test object in block 352.

In some examples, the heating the portion of the test object can include imparting, using a laser, laser light on the portion of the test object.

In some examples, the heating the portion of the test object can include conducting heat to the portion of the test object via contact of the portion of the test object with another object having a temperature higher than that of the portion of the test object.

In some examples, the heating the portion of the test object can include convection heating the portion of the test object via contact of the portion of the test object with a gas having a temperature higher than that of the portion of the test object,

In some examples, the heating the portion of the test object can include imparting radiation on the portion of the test object.

In some examples, the heating the portion of the test object can include induction heating the portion of the test object.

As illustrated in FIG. 3B, at block 356, one or more of the devices described herein can measure, using an infrared sensor, a change in temperature of the portion of the test object.

In some embodiments, the method can further include locating, using a robotic arm, the infrared sensor to a position where the infrared sensor can measure the change in temperature of the test object.

As illustrated in FIG. 3B, at block 358, one or more of the devices described herein can produce, using an optical sensor, information describing an image of thermal change in displacement of the portion of the test object at the higher temperature.

In some embodiments, the method can further include locating, using a robotic arm, the optical sensor to a position where the optical sensor can produce the information describing the image of thermal change in displacement of the portion of the test object at the higher temperature.

As illustrated in FIG. 3B, at block 360, one or more of the devices described herein can perform, automatically and using a computer processor, digital image correlation analysis by comparing the information describing the image of thermal change in displacement of the portion of the test object at the higher temperature to the information describing the reference image to produce strain information describing heating-induced changes in strain in the portion of the test object.

As illustrated in FIG. 3B, at block 362, one or more of the devices described herein can produce CTE information by correlating the strain information with the change in temperature of the portion of the test object.

In some examples, the method 350 can further include forming, from the CTE information, a CTE distribution map that can include at least one of (i) a CTE vector field image or (ii) a CTE histogram image.

In some embodiments, the method 350 can further include calculating, from the CTE information, a change in CTE information over time. In an example, the change in CTE information over time can be determined by identifying a difference between first CTE information produced from earlier information describing a first image of thermal change in displacement of the portion of the test object and second CTE information produced from later information describing a second image of thermal change in displacement of the portion of the test object. In some embodiments, the method 350 can further include calculating residual stress in the portion of the test object from the change in CTE information.

In a non-limiting example, the portion of the test object that is the object of the residual stress calculation can be a portion of a rail track and a time between obtaining the first image of thermal change in displacement of the rail track and the second image of thermal change in displacement of the rail track can be at least one day.

In a non-limiting example, the time between obtaining the first image of thermal change in displacement of the portion of the test object and the second image of thermal change in displacement of the portion of the test object can be at least 200 picoseconds.

We now turn to FIG. 4A.

FIG. 4A depicts an example apparatus configured to measure fiber orientation 400 of at least a portion of a test object 402, when the portion of the test object 402 includes a reinforced composite material. The apparatus configured to measure configured to measure fiber orientation 400 can be configured for perform at least a part of a method described hereby, such as the example method for measuring fiber orientation 450 of at least a portion of a reinforced composite material described in reference to FIG. 4B.

In examples, the test object 402 has a front face 404 and a back face 406. The test object 402 can include a speckle pattern 408. In examples, the test object 302 and the test object 402 are the same test object.

The example apparatus configured to measure fiber orientation 400 can include a heating device configured to heat the portion of the test object 402 (e.g., a heat gun 410), LED lighting 412, a camera 414, or a combination thereof.

The heating device can be configured to heat at least a portion of the test object 402. In examples, the heating device can be a heating device described with reference to FIG. 3A. In some examples, the heating device can be configured to heat the portion of the test object 402 from the front 404 of the test object 402. In some examples, the heating device can be configured to heat the portion of the test object 402 from the back 406 of the test object 402.

The example apparatus configured to measure fiber orientation 400 can include a device configured to apply a speckle pattern to least a portion of the test object 402, such as those patterning devices described with reference to FIG. 3A.

The LED lighting 412 can provide incident light on at least the portion of the test object 402 to enable the camera 414 to produce (i) information describing a reference image of the portion of the test object 402 during low-temperature excitation of the portion of the test object 402, (ii) information describing an image of the portion of the test object 402 at a higher temperature, or (iii) both. In non-limiting examples, the LED lighting 412 can illuminate a speckle pattern for an optical camera to capture images of the portion of the test object 402.

The camera 414 can be configured to produce information describing a visible image of the portion of the test object 402, such as information describing an image of the portion of the test object 402 before heating the portion of the test object 402, during heating the portion of the test object 402, after heating the portion of the test object 402, or a combination thereof. In examples, the camera 414 can be configured to produce information describing an image of a speckle pattern of the portion of the test object 402 before heating the portion of the test object 402, during heating the portion of the test object 402, after heating the portion of the test object 402, or a combination thereof. The camera 414 can be configured to produce information describing an image of a temperature distribution of at least the portion of the test object 402. The temperature distribution can come about as a result of the thermal load applied to the portion of the test object 402 by the heating device. The camera 414 can include an infrared sensor configured to produce information describing a temperature distribution across at least the portion of the test object. The camera 414 can thus provide information describing a temperature of the portion of the test object 402.

In examples, the heat gun 410, the LED lighting 412, the camera 414, or a combination thereof can be electrically coupled to the example computing device 200. The example computing device 200 can be configured to control operation of the heat gun 410, the LED lighting 412, the camera 414, or a combination thereof. The example computing device 200 can be configured to receive information from the heat gun 410, the LED lighting 412, the camera 414, or a combination thereof.

In examples, the example computing device 200 can be configured to perform (e.g., automatically) Digital Image Correlation (DIC) analysis by comparing the image of the portion of the test object 412 at the higher temperature to the reference image to produce strain output information. In some examples, the example computing device 200 can be configured to perform a fiber orientation measurement on the strain output information. The example computing device 200 can also be configured to produce a fiber orientation distribution map image from the fiber orientation measurement.

The example apparatus configured to measure fiber orientation 400 can include a user display coupled to the example computing device 200 and configured to display information describing the fiber orientation measurement, the fiber orientation distribution map image, or a combination thereof.

The example apparatus configured to measure fiber orientation 400 can include a printer coupled to the example computing device 200 and configured to print information describing the fiber orientation measurement, the fiber orientation distribution map image, or a combination thereof.

We now turn to FIG. 4B.

FIG. 4B depicts an example method for measuring fiber orientation 450 of at least a portion of a reinforced composite material. The method for measuring fiber orientation 450 can be performed at least in part by the apparatus described hereby, such as the computing device 200 in FIG. 2, the example apparatus configured to measure fiber orientation 400 in FIG. 4A, or a practicable combination thereof.

As illustrated in FIG. 4B, at block 452, one or more of the devices described herein can produce information describing a reference image of a portion of a reinforced composite material during low-temperature excitation of the portion of the reinforced composite material.

In some examples, external lighting, such as LED lighting 412, can be used to illuminate the portion of the reinforced composite material when camera, such as the camera 414, captures information describing images of at least a portion of a test object such as test object 402.

As illustrated in FIG. 4B, at block 454, one or more of the devices described herein can heat the portion of the reinforced composite material to a higher temperature.

As illustrated in FIG. 4B, at block 456, one or more of the devices described herein can produce, using an infrared sensor, change in temperature information describing an image of the portion of the reinforced composite material at the higher temperature.

As illustrated in FIG. 4B, at block 458, one or more of the devices described herein can produce, using an optical sensor, information describing an image of the portion of the reinforced composite material at the higher temperature. In examples, the provided devices can measure an anisotropic thermal expansion of the portion of the test object. The anisotropic thermal expansion of the portion of the test object can occur due to a stiffness along a fiber axis that resists thermal expansion (e.g., low strain), whereas transverse the fiber axis is a polymer matrix that relatively thermally expands more (e.g., high strain).

As illustrated in FIG. 4B, at block 460, one or more of the devices described herein can perform, automatically and using a computer processor, digital image correlation analysis by comparing the information describing the image of the portion of the reinforced composite material at the higher temperature to the information describing the reference image to produce strain output information.

As illustrated in FIG. 4B, at block 462, one or more of the devices described herein can perform a fiber orientation measurement on the strain output information.

As illustrated in FIG. 4B, at block 464, one or more of the devices described herein can produce a fiber orientation distribution map image from the fiber orientation measurement. In examples, the fiber orientation distribution map can include a fiber orientation vector field image. In some embodiments, the fiber orientation distribution map can include at least one of (i) a fiber orientation vector field image or (ii) a fiber orientation histogram image.

As used hereby, the term “example” means “serving as an example, instance, or illustration”. Any example described as an “example” is not necessarily to be construed as preferred or advantageous over other examples. Likewise, the term “examples” does not require all examples include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

A reference using a designation such as “first,” “second,” and so forth does not limit either the quantity or the order of those elements. Rather, these designations are used as a convenient method of distinguishing between two or more elements or instances of an element. Thus, a reference to first and second elements does not mean only two elements can be employed, or the first element must necessarily precede the second element. Also, unless stated otherwise, a set of elements can comprise one or more elements. In addition, terminology of the form “at least one of: A, B, or C” or “one or more of A, B, or C” or “at least one of the group consisting of A, B, and C” used in the description or the claims can be interpreted as “A or B or C or any combination of these elements”. For example, this terminology can include A, or B, or C, or A and B, or A and C, or A and B and C, or 2A, or 2B, or 2C, and so on.

The terminology used hereby is for the purpose of describing particular examples only and is not intended to be limiting. As used hereby, the singular forms “a,” “an,” and “the” include the plural forms as well, unless the context clearly indicates otherwise. In other words, the singular portends the plural, where practicable. Further, the terms “comprises,” “comprising,” “includes,” and “including,” specify a presence of a feature, an integer, a step, a block, an operation, an element, a component, and the like, but do not necessarily preclude a presence or an addition of another feature, integer, step, block, operation, element, component, and the like.

At least a portion of the methods, sequences, algorithms, or a combination thereof that are described in connection with the examples disclosed hereby can be performed, controlled, initiated, or a combination thereof directly by hardware, by instructions executed by a processor (e.g., a microprocessor, an application specific integrated circuit (ASIC)), or in a combination thereof. In an example, a processor includes multiple discrete hardware components. Instructions can reside in a non-transient storage medium (e.g., a memory device), such as a random-access memory (RAM), a flash memory, a read-only memory (ROM), an erasable programmable read-only memory (EPROM), an electrically erasable programmable read-only memory (EEPROM), a register, a hard disk, a removable disk, a compact disc read-only memory (CD-ROM), any other form of storage medium, the like, or a combination thereof. An example storage medium (e.g., a memory device) can be coupled to the processor so the processor can read information from the storage medium, write information to the storage medium, or both. In an example, the storage medium can be integral with the processor.

Additionally, computer instructions configured to perform, control, initiate, or a combination thereof a sequence of actions described hereby can be stored on a non-transitory computer-readable storage medium. The computer instructions which, upon execution, can cause an associated processor (such as a special-purpose processor) to perform at least a portion of a function described hereby. Additionally, computer instructions configured to perform, control, initiate, or a combination thereof a sequence of actions described hereby can be stored on a non-transitory computer-readable storage medium having stored thereby a corresponding set of instructions that, upon execution, configure the processor to create specific logic circuits. Thus, examples can be in a number of different forms, all of which have been contemplated to be within the scope of the disclosure. In addition, for each of the examples described hereby, a corresponding electrical circuit of any such examples can be described hereby as, for example, “a logic circuit configured to” perform a described action, control a described action, initiate a described action, or a combination thereof.

In an example, when a general-purpose computer (e.g., a processor) can be configured to perform at least a portion of a method described hereby, then the general-purpose computer becomes a special-purpose computer which is not generic and is not a general-purpose computer. In an example, loading a general-purpose computer with special programming can cause the general-purpose computer to be configured to perform at least a portion of a method described hereby. In an example, a combination of two or more related method steps disclosed hereby forms a sufficient algorithm. In an example, a sufficient algorithm constitutes special programming. In an example, special programming constitutes any software which can cause a computer (e.g., a general-purpose computer, a special-purpose computer, etc.) to be configured to perform, control, initiate, or a combination thereof one or more functions, features, steps, algorithms, blocks, or a combination thereof, as disclosed hereby.

Nothing stated or depicted in this application is intended to dedicate any component, step, block, element, feature, object, benefit, advantage, or equivalent to the public, regardless of whether the component, step, block, element, feature, object, benefit, advantage, or the equivalent is recited in the claims. While this disclosure describes examples, changes and modifications can be made to the examples disclosed hereby without departing from the scope defined by the appended claims. A feature from any of the provided examples can be used in combination with one another feature from any of the provided examples in accordance with the general principles described hereby. The present disclosure is not intended to be limited to the specifically disclosed examples alone.

What is claimed is:

1. A method for determining a coefficient of thermal expansion (CTE) of a portion of a test object, comprising:
capturing information describing a reference image of the portion of the test object during low-temperature excitation of the portion of the test object;
heating the portion of the test object from the low-temperature to a higher temperature to produce a local thermal load;
measuring, using an infrared sensor, a change in temperature of the portion of the test object;
producing, using an optical sensor, information describing an image of thermal change in displacement of the portion of the test object at the higher temperature;
performing, automatically and using a computer processor, digital image correlation analysis by comparing the information describing the image of thermal change in displacement of the portion of the test object at the higher temperature to the information describing the reference image to produce strain information describing heating-induced changes in strain in the portion of the test object; and
producing CTE information by correlating the strain information with the change in temperature of the portion of the test object.

2. The method of claim 1, further comprising locating, using a robotic arm, the infrared sensor to a position where the infrared sensor can measure the change in temperature of the test object and the optical sensor to a position where the optical sensor can produce the information describing the image of thermal change in displacement of the portion of the test object at the higher temperature.

3. The method of claim 1, wherein the heating the portion of the test object includes at least one of:
imparting, using a laser, laser light on the portion of the test object;
conducting heat to the portion of the test object via contact of the portion of the test object with another object having a temperature higher than that of the portion of the test object;
convection heating the portion of the test object via contact of the portion of the test object with a gas having a temperature higher than that of the portion of the test object;
imparting radiation on the portion of the test object; or
induction heating the portion of the test object.

4. The method of claim 1, further comprising applying a speckle pattern to the portion of the test object.

5. The method of claim 4, wherein at least a portion of the speckle pattern forms a barcode.

6. The method of claim 4, further comprising forming the speckle pattern by at least one of:
painting the speckle pattern on the portion of the test object;
sputtering a material on the portion of the test object; or
etching the portion of the test object.

7. The method of claim 1, wherein the test object comprises at least one of:
an integrated circuit package;
a printed circuit board;
a solder joint;
a semiconductor cross-section;
a semiconductor structure; or
a semiconductor module.

8. The method of claim 1, wherein the test object comprises a turbine engine component.

9. The method of claim 8, wherein the turbine engine component comprises at least one of:
a spinner;
a fan blade;
a compressor blade;
a compressor stator, or
a shaft.

10. The method of claim 1, wherein the test object comprises at least a portion of a railway vehicle.

11. The method of claim 10, wherein the portion of the railway vehicle comprises:
a wheel;
an axle;
a center plate;
a side frame;
a spring plate;
a bolster; or
a coil spring.

12. The method of claim 1, wherein the test object comprises at least a portion of:
a rail track;
a rail fastener;
a rail weld; or
a railway sleeper.

13. The method of claim 1, wherein the test object comprises a metal additive structure.

14. The method of claim 1, wherein the test object comprises at least two dissimilar materials.

15. The method of claim 1, further comprising forming, from the CTE information, a CTE distribution map comprising at least one of a CTE vector field image or a CTE histogram image.

16. The method of claim 1, further comprising:
calculating, from the CTE information, a change in CTE information over time; and
calculating residual stress in the portion of the test object from the change in CTE information.

17. A system for determining a coefficient of thermal expansion (CTE) of a portion of a test object, comprising:
an optical sensor;
an infrared sensor;
a processor coupled to the optical sensor and the infrared sensor; and
a memory device coupled to the processor and storing instructions configured to cause the processor to control:
capturing information describing a reference image of the portion of the test object during low-temperature excitation of the portion of the test object;
heating the portion of the test object from the low-temperature to a higher temperature to produce a local thermal load;
measuring, using the infrared sensor, a change in temperature of the portion of the test object;
producing, using the optical sensor, information describing an image of thermal change in displacement of the portion of the test object at the higher temperature;
performing, automatically and using the processor, digital image correlation analysis by comparing the information describing the image of thermal change in displacement of the portion of the test object at the higher temperature to the information describing the reference image to produce strain information describing heating-induced changes in strain in the portion of the test object; and
producing CTE information by correlating the strain information with the change in temperature of the portion of the test object.

18. The system of claim 17, further comprising a heating device configured to heat the portion of the test object to the higher temperature.

19. The system of claim 18, wherein the heating device is at least one of:
a laser;
a conduction heater;
a convection heater;
a radiation-generating device; or
an induction heating device.

20. The system of claim 17, further comprising a robotic arm configured to locate the optical sensor and the infrared sensor, wherein the instructions are further configured to cause the processor to locate, using the robotic arm, the infrared sensor to a position where the infrared sensor can measure the change in temperature of the test object and the optical sensor to a position where the optical sensor can produce the information describing the image of thermal change in displacement of the portion of the test object at the higher temperature.

21. The system of claim 17, further comprising a device configured to apply a speckle pattern to the portion of the test object.

22. The system of claim 21, wherein the device is configured to apply the speckle pattern in a manner that forms at least a barcode.

23. The system of claim 21, further comprising at least one of:
a paint application device configured to paint the speckle pattern;
a sputtering device configured to sputter a material to form the speckle pattern; or
an etching device configured to etch the speckle pattern.

24. The system of claim 17, wherein the test object comprises at least one of:
an integrated circuit package;
a printed circuit board;
a solder joint;
a semiconductor cross-section;
a semiconductor structure; or
a semiconductor module.

25. The system of claim 17, wherein the test object comprises a turbine engine component.

26. The system of claim 25, wherein the turbine engine component comprises at least one of:
a spinner;
a fan blade;
a compressor blade;
a compressor stator, or
a shaft.

27. The system of claim 17, wherein the test object comprises at least a portion of a railway vehicle.

28. The system of claim 27, wherein the portion of the railway vehicle comprises:
a wheel;
an axle;
a center plate;
a side frame;
a spring plate;
a bolster; or
a coil spring.

29. The system of claim 17, wherein the test object comprises at least a portion of:
a rail track;
a rail fastener;
a rail weld; or
a railway sleeper.

30. The system of claim 17, wherein the test object comprises a metal additive structure.

31. The system of claim 17, wherein the test object comprises at least two dissimilar materials.

32. The system of claim 17, wherein the memory device further stores instructions configured to cause the processor to control producing a CTE distribution map from the CTE information and further comprising at least one of:
a user display coupled to the processor and configured to display at least a portion of the CTE distribution map; or
a printer coupled to the processor and configured to print at least a portion of the CTE distribution map.

33. The system of claim 17, wherein the memory device further stores instructions configured to cause the processor to control:
calculating, from the CTE information, a change in CTE information over time; and
calculating residual stress in the portion of the test object from the change in CTE information.

34. A non-transitory computer-readable medium, comprising processor-executable instructions stored thereon configured to cause a processor to control:
capturing information describing a reference image of a portion of a test object during low-temperature excitation of a portion of the test object;
heating the portion of the test object from the low-temperature to a higher temperature to produce a local thermal load;
measuring, using an infrared sensor, a change in temperature of the portion of the test object;
producing, using an optical sensor, information describing an image of thermal change in displacement of the portion of the test object at the higher temperature;
performing, automatically and using a computer processor, digital image correlation analysis by comparing the information describing the image of thermal change in displacement of the portion of the test object at the higher temperature to the information describing the reference image to produce strain information describing heating-induced changes in strain in the portion of the test object; and
producing coefficient of thermal expansion (CTE) information by correlating the strain information with the change in temperature of the portion of the test object.

35. The non-transitory computer-readable medium of claim 34, wherein the processor-executable instructions are configured to cause the processor to control a heating device configured to heat the portion of the test object to the higher temperature.

36. The non-transitory computer-readable medium of claim 34, wherein the processor-executable instructions are configured to cause the processor to control the heating the portion of the test object by controlling at least one of:
imparting, using a laser, laser light on the portion of the test object;
conducting heat to the portion of the test object via contact of the portion of the test object with another object having a temperature higher than that of the portion of the test object;
convection heating the portion of the test object via contact of the portion of the test object with a gas having a temperature higher than that of the portion of the test object;
imparting radiation on the portion of the test object; or
induction heating the portion of the test object.

37. The non-transitory computer-readable medium of claim 34, wherein the processor-executable instructions are configured to cause the processor to locate, using a robotic arm, the infrared sensor to a position where the infrared sensor can measure the change in temperature of the test object and the optical sensor to a position where the optical sensor can produce the information describing the image of thermal change in displacement of the portion of the test object at the higher temperature.

38. The non-transitory computer-readable medium of claim 34, wherein the processor-executable instructions are configured to cause the processor to control applying a speckle pattern to the portion of the test object.

39. The non-transitory computer-readable medium of claim 38, wherein at least a portion of the speckle pattern forms a barcode.

40. The non-transitory computer-readable medium of claim 38, wherein the processor-executable instructions are configured to cause the processor to control at least one of:
a paint application device configured to paint the speckle pattern;
a sputtering device configured to sputter a material to form the speckle pattern; or
an etching device configured to etch the speckle pattern.

41. The non-transitory computer-readable medium of claim 34, wherein the test object comprises at least one of:
an integrated circuit package;
a printed circuit board;
a solder joint;
a semiconductor cross-section;
a semiconductor structure; or
a semiconductor module.

42. The non-transitory computer-readable medium of claim 34, wherein the test object comprises a turbine engine component.

43. The non-transitory computer-readable medium of claim 42, wherein the turbine engine component comprises at least one of:
a spinner;
a fan blade;
a compressor blade;
a compressor stator, or
a shaft.

44. The non-transitory computer-readable medium of claim 34, wherein the test object comprises at least a portion of a railway vehicle.

45. The non-transitory computer-readable medium of claim 44, wherein the portion of the railway vehicle comprises:
a wheel;
an axle;
a center plate;
a side frame;
a spring plate;
a bolster; or
a coil spring.

46. The non-transitory computer-readable medium of claim 34, wherein the test object comprises at least a portion of:
a rail track;
a rail fastener;
a rail weld; or
a railway sleeper.

47. The non-transitory computer-readable medium of claim 34, wherein the test object comprises a metal additive structure.

48. The non-transitory computer-readable medium of claim 34, wherein the test object comprises at least two dissimilar materials.

49. The non-transitory computer-readable medium of claim 34, wherein the processor-executable instructions are configured to cause the processor to control forming, from the CTE information, a CTE distribution map comprising at least one of a CTE vector field image or a CTE histogram image.

50. The non-transitory computer-readable medium of claim 34, wherein the processor-executable instructions are configured to cause the processor to control:
calculating, from the CTE information, a change in CTE information over time; and
calculating residual stress in the portion of the test object from the change in CTE information.
